(19) United States
(12) Patent Application Publication
(10) Pub. No.: US 2020/0224624 A1
(43) Pub. Date: Jul. 16, 2020

(54) INJECTOR SYSTEM

(71) Applicant: Robert Bosch GmbH, Stuttgart (DE)

(72) Inventor: Nelly Krause, Hemmingen (DE)

(21) Appl. No.: 16/641,866

(22) PCT Filed: Jun. 29, 2018
(86) PCT No.: PCT/EP2018/067542

§ 371 Date: Feb. 25, 2020

(30) Foreign Application Priority Data
Aug. 28, 2017 (DE) 10 2017 214 980.9

(51) Int. Cl. F02M 61/16; F02M 61/14

(52) U.S. Cl. CPC F02M 61/168; F02M 69/465; F02M 61/14

(57) ABSTRACT

An injector system, in particular a fuel injector system, includes an injector, a housing that at least partially encloses the injector, and a connecting piece that is connected to the injector and includes a connecting area via which the injector is situated in a formfitting manner at the housing.

### CROSS-REFERENCE TO RELATED APPLICATIONS

The present application is the national stage of International Pat. App. No. PCT/EP2018/067542 filed Jun. 29, 2018, and claims priority under 35 U.S.C. § 119 to DE 10 2017 214 980.9, filed in the Federal Republic of Germany on Aug. 28, 2017, the content of each of which are incorporated herein by reference in their entireties.

### FIELD OF THE INVENTION

The present invention relates to an injector system including an injector for injecting a fluid, in particular a fuel injector system.

### BACKGROUND

To attach the injector to an area of the internal combustion engine, in particular to a rail cup of a common rail, a connecting piece is used, a required holding force for holding the injector being provided by a holding element. The holding force of the holding element is transmitted either directly to a housing that encloses the injector or to a disk welded to the housing. The housing can settle, whereby a distance between the injector and the area of the internal combustion engine becomes larger, and the holding element leaves its working area. Hazardous tensions and elongations can occur in the housing that can result in cracks. The cracks result in leakiness of the housing with regard to moisture. Furthermore, the disk is an additional component that firstly has to be positioned and then welded.

### SUMMARY OF THE INVENTION

The injector system according to the present invention, which can be designed in particular as a fuel injector system, has the advantage of a simple and robust construction. This is achieved according to the present invention by an injector system which includes an injector, a housing which at least partially encloses the injector, and a connecting piece.

The connecting piece is connected to the injector and includes a connecting area, via which the injector is situated in a formfitting manner at the housing. The formfitting connection between the injector and the housing prevents settling of the housing. In particular in the event of temperature changes, the formfitting connection prevents a movement of the housing during expansion or shrinking. The strength of the housing is thus maintained and leaks are avoided. Furthermore, there is only one component, namely the connecting piece that is used as the interface to the area of the internal combustion engine, in particular the rail cup, and supports the housing at the same time. An additional component and an additional process for positioning this component in the injector system are thus saved. Moreover, manufacturing such a connecting piece is simple and very cost-effective. The connecting piece is preferably welded at the housing.

The connecting area preferably includes a collar extending radially outward.

The connecting area includes a first end and a second end, the first end being situated in front of the second end in the injection direction. The first end is a rail-side end, the second end being a combustion-chamber-side end. In other words, the first end faces toward a common rail in an installed state of the injector in an internal combustion engine, the second end facing toward a combustion chamber of the internal combustion engine.

The collar particularly preferably widens in the direction from the first end to the second end. In particular, the collar is designed in the shape of a truncated cone.

The connecting area preferably includes at least one groove that is engaged with a protrusion of the housing. The protrusion and the groove preferably have complementary shapes.

Furthermore, the connecting area can preferably include at least one protrusion which is engaged with a groove of the housing. The protrusion and the groove preferably have complementary shapes.

The connecting area is advantageously designed at least partially in the shape of a Christmas tree. “In the shape of a Christmas tree” means that the connecting area includes a plurality of protrusions that are each designed as a right triangle in a longitudinal section. The hypotenuse of the right triangle is preferably located in front of the long perpendicular side in the direction from the first end to the second end of the connecting area.

The housing preferably includes a housing area that is designed to accommodate a holding element for holding the injector system at a component of an internal combustion engine. The connecting area of the injector is situated in direct proximity to the housing area. In particular, the connecting area is situated before or after the housing area or above or below the housing area in a longitudinal direction of the housing. The longitudinal direction corresponds to a longitudinal axis of the housing.

The connecting area is used as a type of hook that ensures that the housing does not settle.

The connecting area is advantageously designed to be rotationally symmetrical. The connecting area particularly preferably extends around a complete circumference of the connecting piece.

Alternatively, the connecting area can preferably only be formed in sections in the circumferential direction of the connecting piece.

The connecting piece is preferably a turned part.

Alternatively, the connecting area can be designed to be asymmetrical. The connecting area can thus preferably include one protrusion or a plurality of protrusions and/or one groove and/or a plurality of grooves that are situated asymmetrically in the circumferential direction, and in particular do not have a rotational symmetry.

The housing is preferably designed as an extrusion-coated part.

Furthermore, the present invention relates to an internal combustion engine that includes an above-described injector system. The injector system is preferably situated at a component, in particular at a common rail. The common rail is also to be understood as a distributor to which multiple injector systems can be attached and that can supply them with fluid, in particular fuel.

Exemplary embodiments of the present invention are described in detail hereafter with reference to the appended drawings, identical or functionally identical component parts each being identified by the same reference numerals in the exemplary embodiments.

### BRIEF DESCRIPTION OF THE DRAWINGS

FIG. 1 shows a schematic simplified view of an injector system situated in an internal combustion engine, according to an example embodiment of the present invention.

FIG. 2 shows a schematic simplified enlarged view of an area of the injector system shown in FIG. 1, according to an example embodiment of the present invention.

FIG. 3 shows a schematic simplified perspective view of a connecting piece provided in the injector system of FIG. 1, according to an example embodiment of the present invention.

FIG. 4 shows a schematic simplified view of an injector system, according to a second example embodiment of the present invention.

FIG. 5 shows a schematic simplified view of an injector system, according to a third example embodiment of the present invention.

FIG. 6 shows a schematic simplified view of an injector system, according to a fourth example embodiment of the present invention.

FIG. 7 shows a schematic simplified view of an injector system, according to a fifth example embodiment of the present invention.

### DETAILED DESCRIPTION

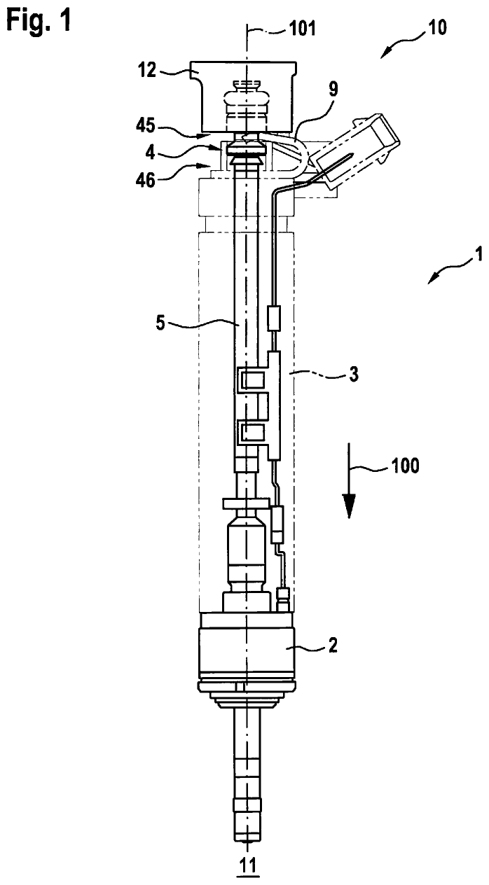

An injector system 1 according to a first example embodiment of the present invention is described in detail hereafter with reference to FIGS. 1-3. FIG. 1 shows an internal combustion engine 10, in which injector system 1 is situated. A holding element 9 is provided for holding injector system 1 at internal combustion engine 10 or in a borehole of internal combustion engine 10. Injector system 1 is attached in particular to a distributor 12 or a common rail of internal combustion engine 10.

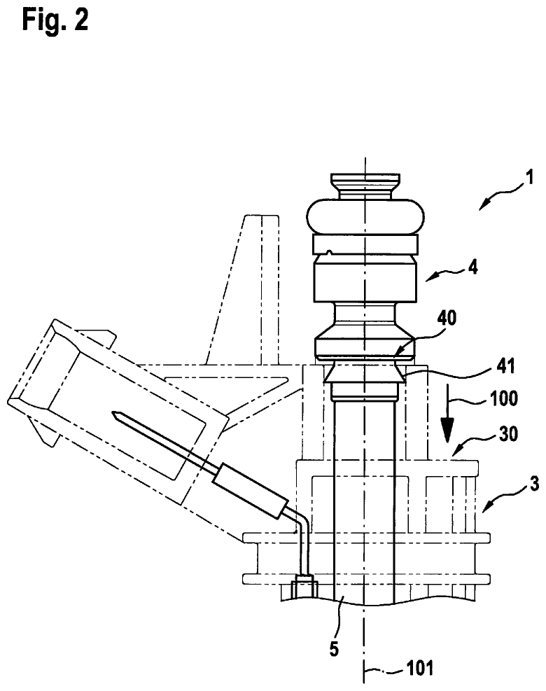

Injector system 1 that is designed in particular as a fuel injector system, includes an injector 2, a housing 3, and a connecting piece 4. Housing 3 at least partially encloses injector 2 and is designed as an extrusion-coated part. Furthermore, connecting piece 4 is connected to injector 2 and includes a connecting area 40, via which injector 2 is situated in a formfitting manner at housing 3. Housing 3 is shown as transparent for a better overview in FIGS. 1 and 2.

Injector 2 is preferably connected to connecting piece 4 using an extension element 5 designed as a pipe.

Connecting area 40 includes a first end 45 and a second end 46, first end 45 being situated before second end 46 in injection direction 100 (FIG. 2). First end 45 is a rail-side end, second end 46 being a combustion-chamber-side end. In other words, first end 45 faces toward common rail 12 in an installed state of injector system 1 in internal combustion engine 10, second end 46 facing toward a combustion chamber 11 of internal combustion engine 10. A longitudinal axis 101 of injector system 1 defines a longitudinal direction.

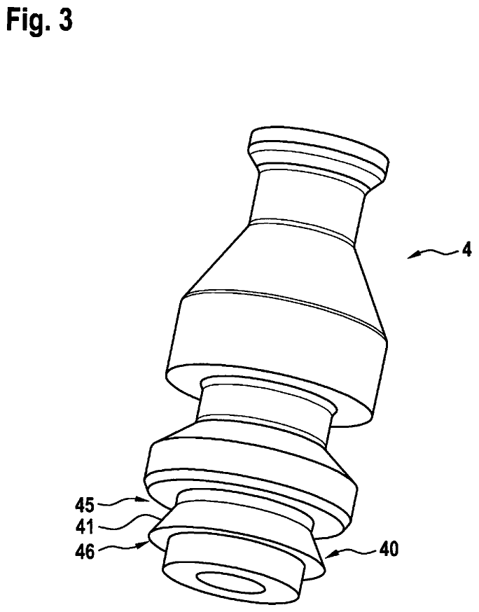

As is apparent from FIGS. 2 and 3, connecting area 40 is advantageously designed to be rotationally symmetrical. Connecting area 40 extends around a complete circumference of connecting piece 4.

In this example embodiment, connecting area 40 includes a collar 41 protruding radially outward. Collar 41 particularly preferably widens in the direction from first end 45 toward second end 46. In particular, collar 41 is designed in the shape of a truncated cone.

Connecting area 40 is situated before a housing area 30 in a direction that corresponds to the direction from first end 45 to second end 46. This means that second end 46 of connecting area 40 is located before housing area 30. Housing area 30 is used as the receptacle area for accommodating holding element 9. The direction from first end 45 to second end 46 corresponds to injection direction 100.

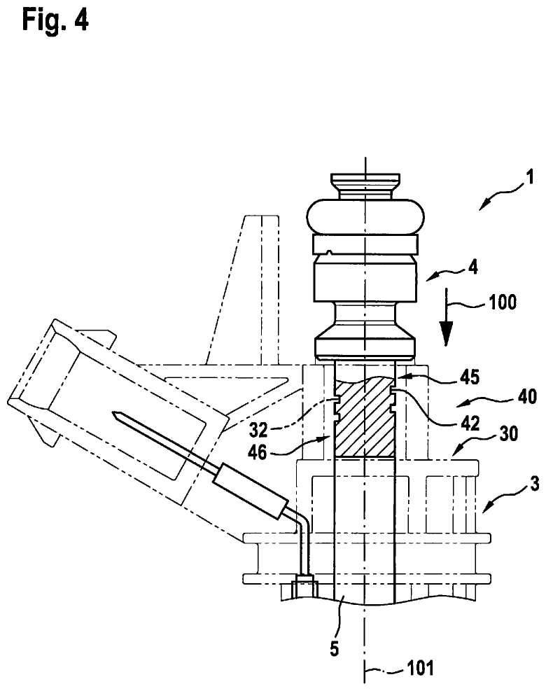

FIG. 4 shows an area of an injector system 1 according to a second example embodiment of the present invention, in which connecting area 40 includes a groove 42 that is engaged with a protrusion 32 of housing 3. Protrusion 32 of housing 3 and groove 42 of connecting area 40 have complementary shapes. In particular, protrusion 32 and groove 42 have a rectangular profile in a longitudinal section. However, other profiles are also possible. Furthermore, groove 42 and protrusion 32 are designed in the shape of a spiral.

Alternatively, connecting area 40 can include a plurality of grooves 42 that are engaged with a plurality of protrusions 32 of housing 3. Grooves 42 are situated in parallel to one another in the direction of longitudinal axis 101. Furthermore, each groove 42 extends around the entire circumference of connecting piece 4. Protrusions 32 are accordingly situated in parallel to one another in the direction of longitudinal axis 101. Furthermore, each protrusion 32 extends completely in the circumferential direction of housing 3. Grooves 42 and protrusions 32 can be designed to be ring-shaped.

As in the first example embodiment, connecting area 40 is situated before housing area 30 in the injection direction.

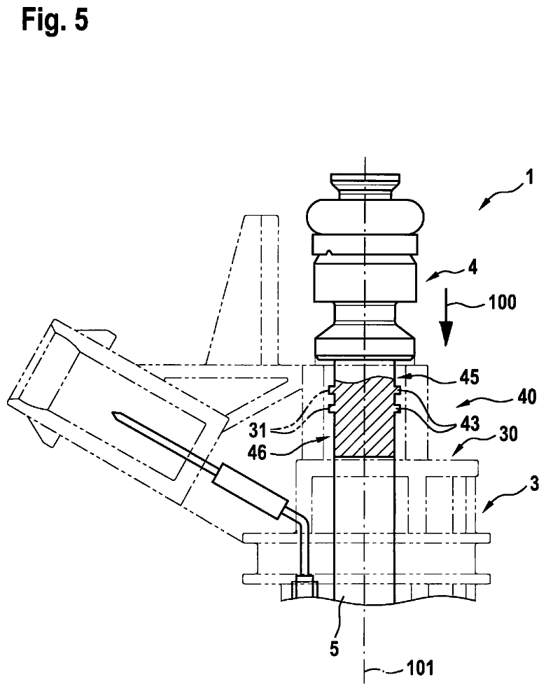

FIG. 5 shows an area of an injector system 1 according to a third example embodiment of the present invention, in which connecting area 40 includes a plurality of protrusions 43 that are engaged with corresponding grooves 31 of housing 3. Protrusions 43 and grooves 31 preferably have complementary shapes. In particular, protrusions 43 and grooves 31 are designed to be ring-shaped and have a rectangular profile in a longitudinal section. Protrusions 43 are situated in parallel to one another in longitudinal direction 101. Accordingly, grooves 31 are situated in parallel to one another in longitudinal direction 101.

Connecting area 40 is situated before housing area 30 in injection direction 100.

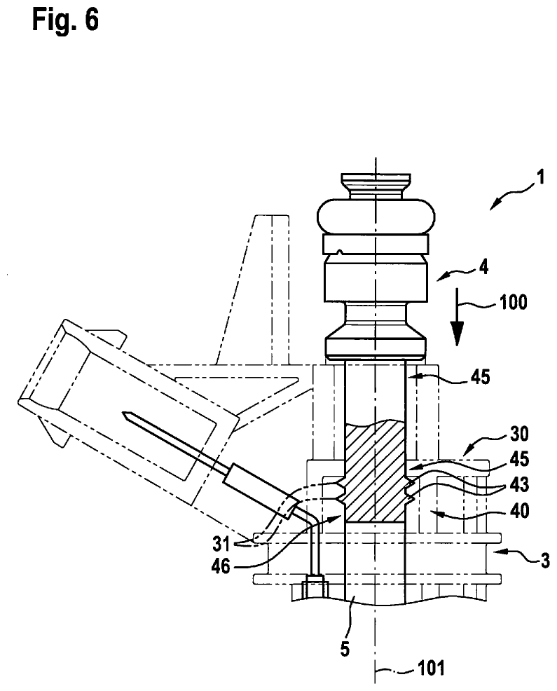

Injector system 1 according to a fourth example embodiment shown in FIG. 6 differs from injector system 1 according to the third example embodiment in that the profile of protrusions 43 and grooves 31 is designed to be triangular. Furthermore, connecting area 40 is located after housing area 30 in injection direction 100. This means that first end 45 of connecting area 40 is situated after housing area 30 in injection direction 100.

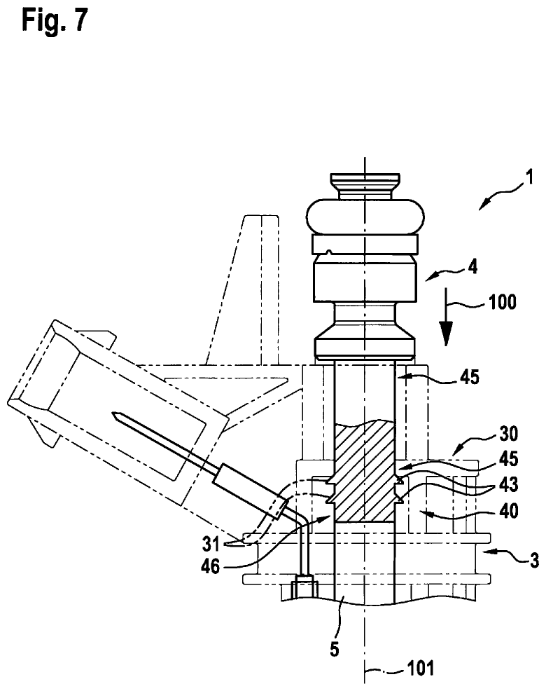

FIG. 7 shows an area of an injector system 1 according to a fifth example embodiment of the present invention, in which connecting area 40 is designed in the shape of a Christmas tree. This means that the connecting area includes a plurality of protrusions 43 that each has a profile of a right triangle in a longitudinal section. The hypotenuse of each right triangle is located before the long perpendicular side in the direction from first end 45 to second end 46. Furthermore, connecting area 40 is located after housing area 30 in injection direction 100.

Connecting area 40 is shown in a sectional view in FIGS. 4-7, housing 3 partially being shown as transparent. Furthermore, connecting area 40 can include an arbitrary combination of the above-described elements.

1-8. (canceled)

9. An injector system comprising:
an injector;
a housing that at least partially encloses the injector; and
a connector that is connected to the injector and that includes a connecting area via which the injector is situated in a formfitting manner at the housing.

10. The injector system of claim 9, wherein the connecting area includes a collar extending radially outward.

11. The injector system of claim 9, wherein the connecting area includes at least one groove engaged with a protrusion of the housing.

12. The injector system of claim 9, wherein the connecting area includes at least one protrusion engaged with a groove of the housing.

13. The injector system of claim 9, wherein the connecting area is at least partially designed in a shape formed of a straight section in which the conncting area extends longitudinally with an approximately unchanging radial size followed by a flaring section that flares radially outward from the straight section.

14. The injector system of claim 9, wherein the connecting area, in cross-section, includes a plurality of protrusions that are each designed as a right triangle in a longitudinal section.

15. The injector system of claim 14, wherein a hypotenuse of the right triangle is located in front of a long perpendicular side of the right triangle in a direction from a first end of the connecting area to a second end of the connecting area, the first end being in front of the second end with respect to an injection direction in which the injector is configured to perform an injection.

16. The injector system of claim 9, wherein:
the housing includes a housing area designed to accommodate a holder that is configured to hold the injector system at a component of an internal combustion engine; and
the connecting area of the connector is situated before or after the housing area in a longitudinal direction.

17. The injector system of claim 9, wherein the housing is designed as an extrusion-coated part.

18. The injector system of claim 9, wherein the injector system is a fuel injector system.

19. An internal combustion engine comprising an injector system, the injector system comprising:
an injector;
a housing that at least partially encloses the injector; and
a connector that is connected to the injector and that includes a connecting area via which the injector is situated in a formfitting manner at the housing.

20. The internal combustion engine of claim 19, further comprising a common rail, wherein the injector system is situated at the common rail.

21. The internal combustion engine of claim 20, wherein:
the injector system further comprises a holder; and
the housing includes a housing area accommodating the holder, the holder thereby holding the injector system at the common rail; and
the connecting area of the connector is situated before or after the housing area in a longitudinal direction.
